(19) United States
(12) Patent Application Publication
(10) Pub. No.: US 2021/0182487 A1
(43) Pub. Date: Jun. 17, 2021

(54) INFORMATION PROCESSING APPARATUS, INFORMATION PROCESSING METHOD, AND PROGRAM

(71) Applicant: SONY CORPORATION, Tokyo (JP)

(72) Inventors: Yuji KITAZAWA, Saitama (JP); Makoto MURATA, Kanagawa (JP); Kazumi HIRANO, Kanagawa (JP); Naoki SHIBUYA, Chiba (JP); Shintaro MASUI, Kanagawa (JP)

(73) Assignee: SONY CORPORATION, Tokyo (JP)

(21) Appl. No.: 16/759,103

(22) PCT Filed: Oct. 1, 2018
(86) PCT No.: PCT/JP2018/036659

§ 371 Date: Apr. 24, 2020

(30) Foreign Application Priority Data
Nov. 1, 2017 (JP) 2017-212052

(51) Int. Cl. G06F 40/279; G10L 13/00; G08B 6/00

(52) U.S. Cl. CPC G06F 40/279; G08B 6/00; G10L 13/00

(57) ABSTRACT

There is provided an information processing apparatus to easily impress on the user the important piece of the text data when the sound image outputs the voice for reading aloud the text data. The information processing apparatus includes a control section. The control section analyzes text data, determines importance levels of respective pieces of the text data, and varies a localization position of a sound image of speech voice of the text data with respect to a user in accordance with the importance levels.

### TECHNICAL FIELD

The present technology relates to a technology of varying a localization position of a sound image.

### BACKGROUND ART

Conventionally, technologies capable of varying a localization position of a sound image have been widely known (see Patent Literatures 1 and 2 listed below). Such technologies make it possible to localize a sound image at various distances in various directions relative to a user.

### CITATION LIST

### Patent Literature

Patent Literature 1: JP 2012-178748A
Patent Literature 2: WO 2016/185740 A1

### DISCLOSURE OF INVENTION

### Technical Problem

According to the conventional technologies, text data is read aloud in a monotone voice when a sound image outputs voice for reading aloud the text data. Therefore, the conventional technologies include a problem that it is difficult to impress on the user an important piece of the text data.

In view of the circumstances as described above, a purpose of the present technology is to provide a technology capable of easily impressing on the user the important piece of the text data when the sound image outputs the voice for reading aloud the text data.

### Solution to Problem

An information processing apparatus according to the present technology includes a control section. The control section analyzes text data, determines importance levels of respective pieces of the text data, and varies a localization position of a sound image of speech voice of the text data with respect to a user in accordance with the importance levels.

This makes it possible to easily impress on the user an important piece of the text data when the sound image outputs voice for reading aloud the text data.

In the information processing apparatus, the control section may vary the localization position of the sound image in such a manner that a distance r of the sound image with respect to the user varies in a spherical coordinate system in accordance with the importance levels.

In the information processing apparatus, the control section may vary the localization position of the sound image in such a manner that an amplitude θ of the sound image with respect to the user varies in a spherical coordinate system in accordance with the importance levels.

In the information processing apparatus, the control section may vary the localization position of the sound image in such a manner that an amplitude φ of the sound image with respect to the user varies in a spherical coordinate system in accordance with the importance levels.

In the information processing apparatus, the control section may be capable of moving the sound image at a predetermined speed, and vary the speed in accordance with the importance levels.

In the information processing apparatus, the control section may vary the number of sound images in accordance with the importance levels.

In the information processing apparatus, the control section may vary sound to be output from the sound image in accordance with the importance levels.

The information processing apparatus may include at least one of an aroma generation section that generates aroma, a vibration section that generates vibration, or a light generation section that generates light. The control section may vary at least one of the aroma, the vibration, or the light in accordance with the importance levels.

In the information processing apparatus, the control section may select any one of a plurality of preliminarily prepared variation patterns of the localization position of the sound image, and vary the localization position of the sound image on the basis of the selected variation pattern.

The information processing apparatus may further include a sensor that outputs a detection value based on behavior of the user. The control section may recognize the behavior of the user on the basis of the detection value, and select any one of the plurality of variation patterns in response to the behavior.

In the information processing apparatus, the control section may vary magnitude of the variation in the localization position of the sound image over time.

In the information processing apparatus, the control section may acquire user information unique to the user, and determine the importance levels in accordance with the user information.

The information processing apparatus may further include: a first vibration section that is located in a first direction relative to the user; and a second vibration section that is located in a second direction different from the first direction. The text data may include information indicating a traveling direction that the user should follow. The control section may vibrate a vibration section corresponding to the traveling direction between the first vibration section and the second vibration section.

In the information processing apparatus, the control section may vibrate the vibration section corresponding to the traveling direction at a timing other than a timing of reading aloud the traveling direction that the user should follow.

In the information processing apparatus, the text data may include information related to a location ahead of the traveling direction, and the control section may vibrate at least one of the first vibration section or the second vibration section in conformity with a timing of reading aloud the information related to the location ahead of the traveling direction.

In the information processing apparatus, the text data may include information related to a location ahead of a direction other than the traveling direction, and the control section may vibrate a vibration section corresponding to the direction other than the traveling direction between the first vibration section and the second vibration section.

In the information processing apparatus, the control section may vibrate the vibration section corresponding to the direction other than the traveling direction in conformity with the timing of reading aloud the traveling direction that the user should follow, detect whether or not the user has reacted to the vibration, and cause output of voice for reading aloud the information related to the location ahead of the direction other than the traveling direction in the case where the user has reacted.

An information processing method according to the present technology includes: analyzing text data; determining importance levels of respective pieces of the text data; and varying a localization position of a sound image of speech voice of the text data with respect to a user in accordance with the importance levels.

A program according to the present technology causes a computer to execute processes of: analyzing text data; determining importance levels of respective pieces of the text data; and varying a localization position of a sound image of speech voice of the text data with respect to a user in accordance with the importance levels.

### Advantageous Effects of Invention

As described above, according to the present technology, it is possible to provide a technology capable of easily impressing on a user an important piece of text data when a sound image outputs voice for reading aloud the text data.

### BRIEF DESCRIPTION OF DRAWINGS

FIG. 1 is a perspective view of a wearable device according to a first embodiment of the present technology.

FIG. 2 is a block diagram illustrating an internal configuration of the wearable device.

FIG. 3 is a flowchart illustrating processes performed by a control section.

FIG. 4 is a diagram illustrating a localization position of a sound image with respect to a head of a user.

FIG. 5 is a diagram illustrating an example of a case of varying only a radius r in accordance with importance levels among the radius r, an amplitude θ, and an amplitude φ.

FIG. 6 is a diagram chronologically illustrating variation in a localization position of a sound image 9 in accordance with the importance levels.

FIG. 7 is a diagram illustrating an example of a case of varying only the amplitude θ in accordance with the importance levels among the radius r, the amplitude θ, and the amplitude φ.

FIG. 8 is a diagram illustrating an example of a case of varying only the amplitude φ in accordance with the importance levels among the radius r, the amplitude θ, and the amplitude φ.

FIG. 9 is a diagram illustrating an example of a case of varying the radius r and the amplitude θ in accordance with the importance levels among the radius r, the amplitude θ, and the amplitude φ.

FIG. 10 is a diagram illustrating an example of a case of varying the radius r and the amplitude φ in accordance with the importance levels among the radius r, the amplitude θ, and the amplitude φ.

FIG. 11 is a diagram illustrating an example of a case of varying movement speed of the sound image in accordance with the importance levels.

FIG. 12 is a diagram illustrating an example of a case of varying the number of sound images in accordance with the importance levels.

FIG. 13 is a top view of a wearable device according to a second embodiment.

FIG. 14 is a flowchart illustrating processes performed by the control section.

FIG. 15 is a flowchart illustrating processes performed by the control section.

FIG. 16 is a flowchart illustrating processes performed by the control section.

FIG. 17 is a diagram illustrating a situation where a vibration section located on a right side of the user is vibrated.

### MODE(S) FOR CARRYING OUT THE INVENTION

Hereinafter, embodiments of the present technology will be described with reference to the drawings.

### First Embodiment

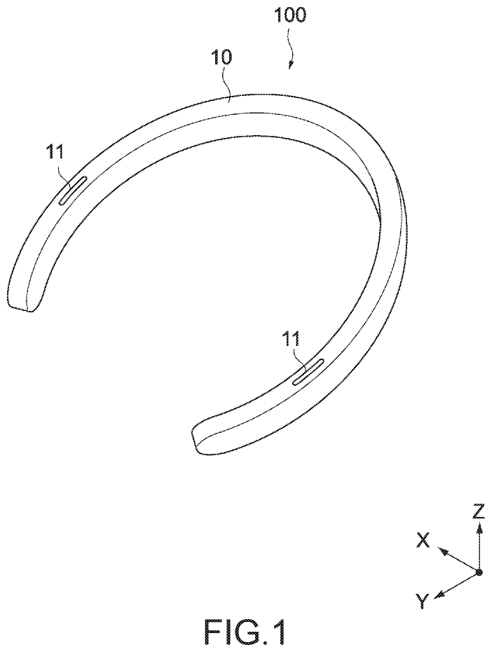

FIG. 1 is a perspective view of a wearable device 100 according to a first embodiment of the present technology. The wearable device 100 illustrated in FIG. 1 is a neckband-type wearable device 100 used while being worn on a neck of a user.

As illustrated in FIG. 1, the wearable device 100 includes a casing 10 having a ring-like shape with an opened portion. When the wearable device 10 is worn on the neck of the user, the wearable device 100 is used while the opened portion is located on a front side of the user.

In addition, the casing 10 includes two openings 11 on its top surface. The openings 11 output sound from speakers 7. The positions of the openings 11 are adjusted in such a manner that the openings 11 are located under ears when the wearable device 10 is worn on the neck of the user.

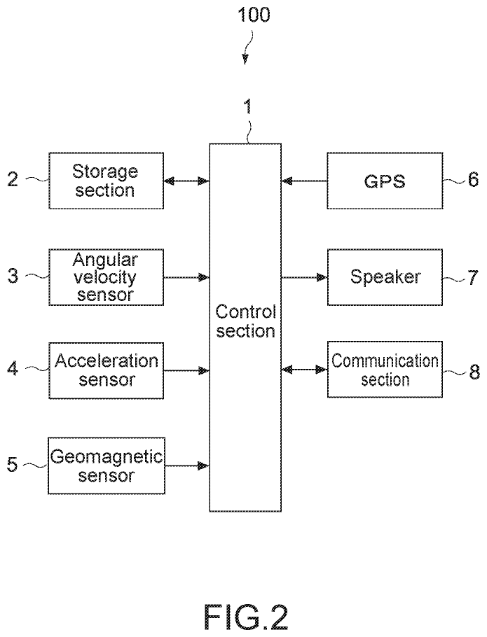

FIG. 2 is a block diagram illustrating an internal configuration of the wearable device 100. As illustrated in FIG. 2, the wearable device 100 includes a control section 1, a storage section 2, an angular velocity sensor 3, an acceleration sensor 4, a geomagnetic sensor 5, a Global Positioning System (GPS) 6, the speakers 7, and a communication section 8.

The control section 1 includes a central processing unit (CPU) or the like, and integrally controls respective structural elements of the wearable device 100, for example. Processes performed by the control section 1 will be described later in paragraphs related to description of behavior.

The storage section 2 includes non-volatile memory that fixedly stores various kinds of data and various kinds of programs, and volatile memory used as a workspace of the control section 1. The programs may be read out from a portable recording medium such as an optical disc or a semiconductor device, or may be downloaded from a server apparatus on a network.

The angular velocity sensor 3 detects angular velocity about three axes (X, Y, and Z axes) of the wearable device 100, and outputs information regarding the detected angular velocity about the three axes to the control section 1. The acceleration sensor 4 detects accelerations in three axis directions of the wearable device 100, and outputs information regarding the detected accelerations in the three axis directions to the control section 1. The geomagnetic sensor 5 detects angles (cardinal directions) about the three axes of the wearable device 100, and outputs information regarding the detected angles (cardinal directions) to the control section 1. According to the present embodiment, the number of detection axes of each sensor are three. However, the number of detection axes may be one or two.

The GPS 6 receives radio waves from a GPS satellite, detects positional information of the wearable device 100, and outputs the positional information to the control section 1.

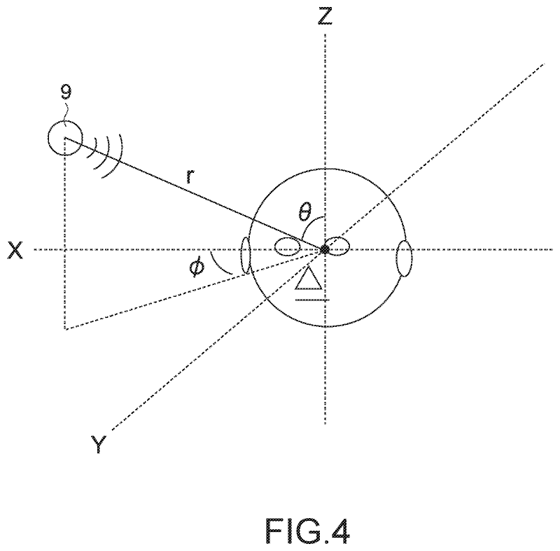

The respective speakers 7 are provided under the two openings 11. The speakers 7 reproduces sound under the control of the control section 1, and this makes it possible to cause the user to recognize the sound as if the sound were output from a sound image 9 (a sound source, see FIG. 4 and the like) localized at a specific position in a space. Note that, according to the present embodiment, the number of speakers 7 is two. However, the number of speakers 7 is not specifically limited.

The communication section 8 communicates with other equipment in a wired or wireless manner.

<Description of Operation>

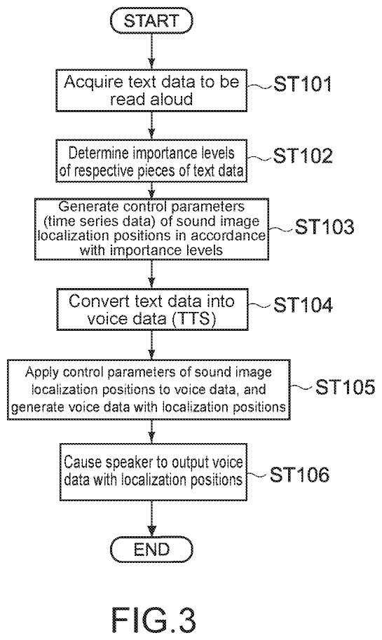

Next, processes performed by the control section 1 will be described. FIG. 3 is a flowchart illustrating processes performed by the control section 1.

In the flowchart illustrated in FIG. 3, the control section 1 executes a process of analyzing text data, determining importance levels of respective pieces of the text data, and varying the localization position of the sound image 9 of speech voice of the text data with respect to the user in accordance with the importance levels.

With regard to description related to FIG. 3, it is assumed that the user who is wearing the wearable device 100 rides a car, a motorcycle, a bicycle, or the like, and heads to a destination in accordance with navigation voice, as an example.

To facilitate understanding, here, the description will be given in detail with reference to examples with regard to a situation where the wearable device 100 is used and voice output from the speakers 7. However, the present technology is applicable to any technologies regardless of situations or types of voice as long as sound output sections such as the speakers 7 outputs voice (speech).

[Determination of Importance Level]

With reference to FIG. 3, the control section 1 first acquires text data to be read aloud from the storage section 2 (Step 101). The text data is a source of the voice to be output from the speakers 7. Next, the control section 1 analyzes the text data and determines importance levels of respective pieces of the text data (Step 102).

Here, it is assumed that the importance levels are determined with regard to the text data for navigation. An example of the text data may be “After 500 meters, turn right. Then you will hit a 1-km-long traffic jam. If you do not turn right but go straight, beautiful scenery will be seen”. Note that, the text data may be any text data such as text data regarding an email, news, a book (such as a novel or a magazine) or data regarding a document.

The storage section 2 stores character strings in advance. The character strings serve as comparison targets for determining the importance levels of the pieces of the text data. In this example, it is assumed that character strings related to directions, character strings related to units of distance, and character strings related to road conditions are stored as the character strings for determining the importance levels.

The character strings related to directions include words such as turn right, turn left, go straight, go straight ahead, take a slight right, take a slight left, and the like, for example. In addition, the character strings related to the units of distance include m, meter, km, kilometer, mi., mile, ft., foot, and the like. In addition, the character strings related to the road conditions include a traffic jam, a gravel road, a bumpy road, a flat road, a slope, a steep slope, a gentle slope, a sharp curve, a gentle curve, road work ahead, and the like.

In addition, the storage section 2 stores user information specific to the user for determining the importance levels of the pieces of the text data. The user information is individual information related to favorability of the user. According to the present embodiment, the user information includes information regarding user's favorite thing, and degrees of favorability of them (how much the user likes them).

For example, the user preliminarily sets the user information via a setting screen by using other equipment such as a personal computer (PC) or a smartphone. The user inputs words related to the user's favorite things such as “beautiful scenery”, “ramen restaurant”, and “Italian restaurant” to the setting screen. Alternatively, the user selects the user's favorite things from among “beautiful scenery”, “ramen restaurant”, “Italian restaurant” and the like that are prepared in advance on the setting screen.

The setting screen also allows the user to select the degrees of favorability of the user's favorite things. According to the present embodiment, it is possible to select the degrees of favorability from four stages including one star to four stars. Note that, it is possible to appropriately change the number of stages regarding the degrees of favorability.

The user information set via the setting screen is received by the wearable device 100 directly or indirectly via the communication section 8, and the storage section 2 stores the user information in advance.

Note that, it is also possible to set the individual information related to the favorability of the user through user behavior recognition based on various kinds of sensors such as the angular velocity sensor 3, the acceleration sensor 4, the geomagnetic sensor 5, and the GPS 6. Note that, it is also possible for the wearable device 100 to include an imaging section to improve accuracy of the behavior recognition.

For example, it is determined that the user likes watching a TV if it is recognized that the user has been watching the TV for a long time through the behavior recognition. In addition, it is determined that the user likes ramen if it is recognized that the user has frequently visited ramen restaurants through the behavior recognition.

The control section 1 treats directions, a distance to a location (an intersection) whose direction is indicated through navigation, road conditions, and the user's favorite things, as important pieces of the text data for the navigation.

With regard to the directions, the control section 1 treats a word that matches any one word included in the character strings (such as turn right and turn left) related to the preliminarily stored directions, as a direction (important piece). The importance levels of various kinds of words such as turn right, turn left, and go straight are the same (such as importance level 3).

Note that, in the present embodiment, the description is given on the assumption that the importance levels are classified into five stages including importance level 0 to importance level 4). However, it is possible to appropriately change the number of stages.

With regard to the distance to the intersection, the control section 1 treats a numerical digit or a word (such as m or km) indicating a unit of distance as the distance to the intersection (important piece), in the case where the numerical digit or the word (such as m or km) indicating a unit of distance exists immediately before a word (such as turn right or turn left) related to a distance (note that, the word “after” in the sentence “after XX meters” is also treated as an important piece). In this case, the control section 1 sets a higher importance level as the distance gets shorter.

With regard to the road conditions, the control section 1 treats a word that matches any one word included in the character strings (such as traffic jam and steep slope) related to the preliminarily stored road conditions, as a road condition (important piece).

In this case, the control section 1 determines the importance level on the basis of a numerical value that comes before a word related to a road condition (such as a numerical digit like “1 km” before the words “traffic jam”) or an adjective included in words related to a road condition (such as a word “steep” included in words “steep slope”). For example, the control section 1 assigns a higher importance level to a road condition as the traffic jam has a longer length, and the control section 1 assigns a higher importance level to a road condition as the slope is steeper.

With regard to the user's favorite things, the control section 1 treats a word that matches any one word included in the character strings (such as beautiful scenery and ramen restaurant) related to the user's favorite things in the user information, as user's favorite thing (important piece).

Note that, even when words do not completely match words related to a favorite thing, the control section 1 treats words determined to be similar to the words related to the favorite thing through similarity determination, as user's favorite thing (fluctuation absorption).

For example, in the case where the words “beautiful scenery” are registered as the user information, “gorgeous scenery” is treated as user's favorite thing. In addition, in the case where the words “ramen restaurant” are registered as the user information, a “ramen shop” is treated as user's favorite thing.

The importance level of the user's favorite thing is determined on the basis of the degrees of favorability included in the user information.

Next, a specific example in which an importance level determination process is applied to a string of text data will be described. Here, it is assumed that, “beautiful scenery” (its degree of favorability is rated as four stars), “ramen restaurant” (its degree of favorability is rated as three stars), and “Italian restaurant” (its degree of favorability is rated as two stars) are registered as user's favorite things in the user information.

In addition, in the following output examples, underlined parts indicate parts determined to be important, and non-underlined parts indicate parts determined to be not important (its importance level is zero).

### First Input Example

“After 500 meters, turn right. Then you will hit a 1-km-long traffic jam. If you do not turn right but go straight, a nice Italian restaurant will be seen.”

### First Output Example

“After 500 meters (importance level 3), turn right (importance level 3). Then you will hit a 1-km-long traffic jam (importance level 3). If you do not turn right but go straight, a nice Italian restaurant (importance level 2) will be seen.”

### Second Input Example

“After 50 meters, turn left. Then you will hit a 10-km-long traffic jam. If you do not turn right but go straight, beautiful scenery will be seen.”

### Second Output Example

“After 50 meters (importance level 4), turn left (importance level 3). Then you will hit a 10-km-long traffic jam (importance level 4). If you do not turn right but go straight, beautiful scenery (importance level 4) will be seen.”

### Third Input Example

“After 1 km, turn left. Then you will hit a 500-meters-long traffic jam. If you do not turn right but go straight, gorgeous scenery will be seen.”

### Third Output Example

“After 1 km (importance level 2), turn left (importance level 3). Then you will hit a 500-meters-long traffic jam (importance level 2). If you do not turn right but go straight, gorgeous scenery (importance level 4) will be seen.”

### Fourth Input Example

“After 1 km, take a slight left. Then you will hit gentle slopes. Then turn right, and a ramen restaurant will be seen.”

### Fourth Output Example

“After 1 km (importance level 2), take a slight left (importance level 3). Then you will hit gentle slopes (importance level 2). Then turn right, and a ramen restaurant (importance level 3) will be seen.”

### Fifth Input Example

“After 1 km, take a slight right. Then you will hit steep slopes. Then turn right, and a ramen shop will be seen.”

### Fifth Output Example

“After 1 km (importance level 2), take a slight right (importance level 3). Then you will hit steep slopes (importance level 4). Then turn right, and a ramen shop (importance level 3) will be seen.”

[Sound Image Localization Process]

After the importance levels of respective pieces of the text data are determined, the control section 1 then calculates control parameters (time series data indicating which position the sound image 9 is localized at when each piece of the text data is read aloud) of localization positions of the sound image 9 in accordance with the determined importance levels (Step 103).

Next, the control section 1 converts the text data into voice data through a text-to-speech (TTS) process (Step 104). Next, the control section 1 applies the control parameters of the localization positions of the sound image 9 to the voice data, and generates voice data with the localization positions (Step 105). Subsequently, the control section 1 causes the speakers 7 to output the voice data with the localization positions (Step 106).

This makes it possible to vary the localization position of the sound image 9 in accordance with the importance levels of respective pieces of the text data when the speakers 7 outputs sound and the respective pieces of the text data are read aloud.

[Method of Varying Sound Image Localization Position]

Next, a specific example of a method of varying a sound image localization position in accordance with importance levels will be described.

FIG. 4 is a diagram illustrating a localization position of the sound image 9 with respect to the head of the user. In FIG. 4, a spherical coordinate system is set while the center of the head of the user is used as its origin. In the spherical coordinate system, a radius r represents a distance r between the user (the head) and the sound image 9, and an amplitude θ represents an inclination angle of the radius r with respect to a Z axis of a Cartesian coordinate system. In addition, an amplitude φ represents an inclination angle of the radius r with respect to an X axis of the Cartesian coordinate system.

According to the present embodiment, the control section 1 includes the spherical coordinate system having the radius r, the amplitude θ, and the amplitude φ therein, and decides localization positions of the sound image 9 in the spherical coordinate system. Note that, the spherical coordinate system and the Cartesian coordinate system illustrated in FIG. 3 are coordinate systems based on the user wearing the wearable device 100 (or based on the wearable device 100). When the user moves, the coordinate systems change in response to the movement of the user. For example, a Z axis direction is a direction of gravitational force when the user is standing. A Y axis direction is the direction of gravitational force when the user is lying face up.

(First Variation Method of Varying Radius r Only)

A first method of varying the sound image localization position is a method of varying only the radius r (the distance r between the user and the sound image 9) in accordance with the importance levels among the radius r, the amplitude θ, and the amplitude φ in the spherical coordinate system. Note that, the amplitude θ and the amplitude φ are assumed to be fixed values regardless of the importance levels. It is possible to arbitrarily decide these values.

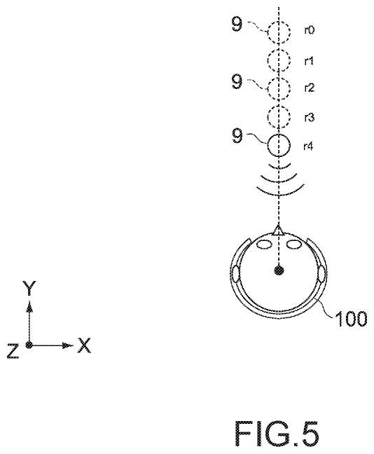

FIG. 5 is a diagram illustrating an example of a case of varying only the radius r in accordance with importance levels among the radius r, the amplitude θ, and the amplitude φ. In FIG. 5, both the amplitude θ and the amplitude φ are set to 90°, and the radius r varies in front of the user.

In the case of varying the radius r (the distance r between the user and the sound image 9), the radius r is set in such a manner that the radius r gets smaller as the importance level increases, for example. In this case, it is possible for the user to intuitively feel that the importance level is high. Note that, conversely, it is also possible to set the radius r in such a manner that the radius r gets larger as the importance level increases.

In the example illustrated in FIG. 5, the radius r decreases in order of a radius r0, a radius r1, a radius r2, a radius r3, a radius r4. An importance level 0 is assigned to the radius r0, an importance level 2 is assigned to the radius r1, an importance level 3 is assigned to the radius r3, and an importance level 4 is assigned to the radius r4.

The radius r0 to the radius r4 may be optimized for each user. For example, the control section 1 may set the radius r0 to the radius r4 on the basis of the user information set by the user via other equipment such as the smartphone (the user sets the radius r via the setting screen). Note that, an amplitude θ0 to an amplitude θ4, an amplitude φ0 to an amplitude φ4, an angular velocity ω0 to an angular velocity ω4 (movement speed), the number of sound images 9, and the like may also be optimized for each user.

For example, a case where sentences “After 1 km (importance level 2), take a slight right (importance level 3). Then you will hit steep slopes (importance level 4). Then turn right, and a ramen shop (importance level 3) will be seen.” are read aloud by voice, will be described.

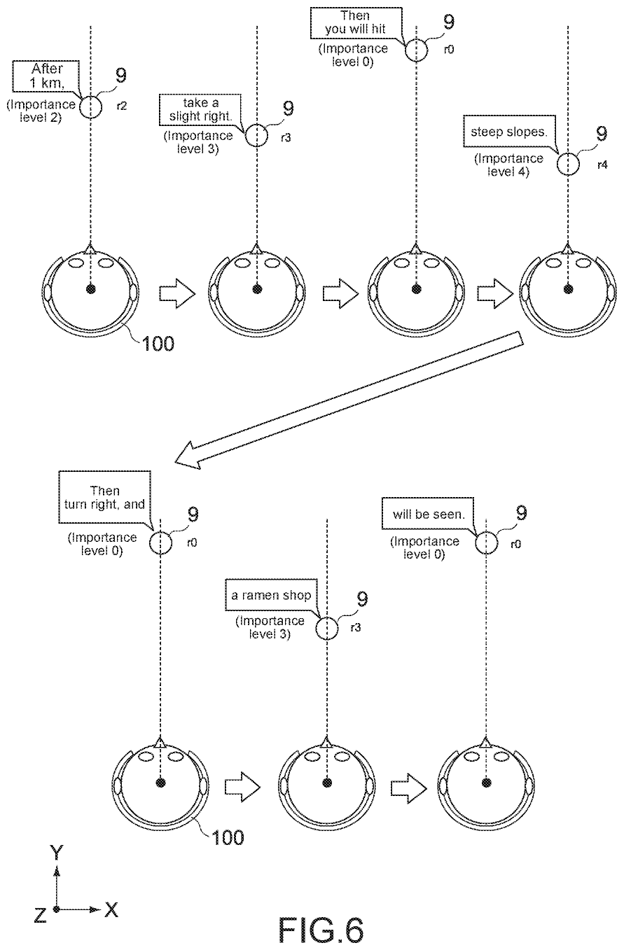

FIG. 6 is a diagram chronologically illustrating variation in the localization position of the sound image 9 in accordance with the importance levels.

With reference to FIG. 6, first of all, because the importance level of the words “After 1 km” is 2, the sound image 9 is localized at the position of the radius r2, and the voice “After 1 km” is heard from the position of the sound image 9.

Next, because the importance level of the words “take a slight right” is 3, the sound image 9 is localized at the position of the radius r3, and the voice “take a slight right” is heard from the position of the sound image 9. At this time, it is also possible to vary the amplitude φ and move the sound image 9 to the right regardless of the importance level. In other words, it is also possible to vary the amplitude φ in accordance with information indicating a traveling direction. Note that, it is also possible to vary the amplitude θ in the case where the text data includes a word such as “up” or “down”.

Next, because the importance level of the words “Then you will hit” is 0, the sound image 9 is localized at the position of the radius r0, and the voice “Then you will hit” is heard from the position of the sound image 9.

Next, because the importance level of the words “steep slopes” is 4, the sound image 9 is localized at the position of the radius r4, and the voice “steep slopes” is heard from the position of the sound image 9. Next, because the importance level of the words “Turn right, then” is 0, the sound image 9 is localized at the position of the radius r0, and the voice “Turn right, then” is heard from the position of the sound image 9.

Next, because the importance level of the words “a ramen shop” is 3, the sound image 9 is localized at the position of the radius r3, and the voice “a ramen shop” is heard from the position of the sound image 9. Next, because the importance level of the words “will be seen” is 0, the sound image 9 is localized at the position of the radius r0, and the voice “will be seen” is heard from the position of the sound image 9.

(Second Variation Method of Varying Amplitude θ Only)

A second method of varying the sound image localization position is a method of varying only the amplitude θ in accordance with the importance levels among the radius r, the amplitude θ, and the amplitude φ in the spherical coordinate system. Note that, the radius r and the amplitude φ are assumed to be fixed values regardless of the importance levels. It is possible to arbitrarily decide these values.

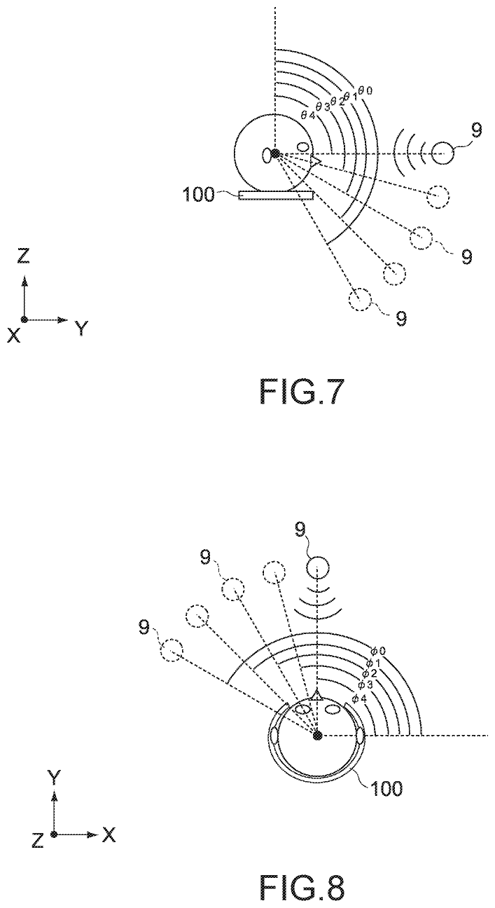

FIG. 7 is a diagram illustrating an example of a case of varying only the amplitude θ in accordance with the importance levels among the radius r, the amplitude θ, and the amplitude φ. In FIG. 7, the amplitude φ is set to 90°, and the amplitude θ varies in front of the user.

In the case of varying the amplitude θ, the amplitude θ is set in such a manner that the height of the sound image 9 gets closer to the height of the head (ears) of the user as the importance level increases, for example. In this case, it is possible for the user to intuitively feel that the importance level is high. Note that, conversely, it is also possible to set the amplitude θ in such a manner that the height of the sound image 9 gets away from the height of the head as the importance level increases.

In the example illustrated in FIG. 7, the height of the sound image 9 gets closer to the height of the center of the head in order of an amplitude θ0, an amplitude θ1, an amplitude θ2, an amplitude θ3, an amplitude θ4. The importance level 0 is assigned to the amplitude θ0, the importance level 1 is assigned to the amplitude θ1, the importance level 2 is assigned to the amplitude θ2, the importance level 3 is assigned to the amplitude θ3, and the importance level 4 is assigned to the amplitude θ4.

In the example illustrated in FIG. 7, the localization position of the sound image 9 gets closer to the head in order from bottom to top. However, the localization position of the sound image 9 may get closer to the head in order from top to bottom.

(Third Variation Method of Varying Amplitude φ Only)

A third method of varying the sound image localization position is a method of varying only the amplitude φ in accordance with the importance levels among the radius r, the amplitude θ, and the amplitude φ in the spherical coordinate system. Note that, the radius r and the amplitude θ are assumed to be fixed values regardless of the importance levels. It is possible to arbitrarily decide these values.

FIG. 8 is a diagram illustrating an example of a case of varying only the amplitude φ in accordance with the importance levels among the radius r, the amplitude θ, and the amplitude φ. In FIG. 8, the amplitude θ is set to 90°, and the amplitude φ varies at the position of the head of the user.

In the case of varying the amplitude φ, the amplitude φ is set in such a manner that the position of the sound image 9 gets closer to the front side of the user as the importance level increases, for example. In this case, it is possible for the user to intuitively feel that the importance level is high. Note that, conversely, it is also possible to set the amplitude θ in such a manner that the position of the sound image 9 gets away from the front side of the user as the importance level increases.

In the example illustrated in FIG. 8, the position of the sound image 9 gets closer to the front side of the head in order of an amplitude φ0, an amplitude φ1, an amplitude φ2, an amplitude φ3, an amplitude φ4. The importance level 0 is assigned to the amplitude φ0, the importance level 1 is assigned to the amplitude φ1, the importance level 2 is assigned to the amplitude φ2, the importance level 3 is assigned to the amplitude φ3, and the importance level 4 is assigned to the amplitude φ4.

In the example illustrated in FIG. 8, the localization position of the sound image 9 gets closer to the front side in order from the left side to the front side. However, the localization position of the sound image 9 may get closer to the front side in order from the right side to the front side.

Alternatively, in the case of varying the amplitude φ, the amplitude φ may be set in such a manner that the position of the sound image 9 gets closer to the position of an ear of the user (that is, the X axis illustrated in FIG. 4) as the importance level increases, for example. In this case, it is possible for the user to intuitively feel that the importance level is high. Note that, conversely, it is also possible to set the amplitude φ in such a manner that the position of the sound image 9 gets away from the position of the ear of the user as the importance level increases.

In addition, when the importance level is 0, the sound image 9 is localized on the front side, and then the localization position of the sound image 9 may vary in the right and left directions relative to the user in accordance with the importance levels. In this case, for example, the localization positions of the sound image 9 corresponding to the importance levels 1 and 2 are on the right side of the user, and the localization positions of the sound image 9 corresponding to the importance levels 3 and 4 are on the left side of the user.

(Fourth Variation Method of Varying Radius r and Amplitude θ)

A fourth method of varying the sound image localization position is a method of varying the radius r and the amplitude θ in accordance with the importance levels among the radius r, the amplitude θ, and the amplitude φ in the spherical coordinate system. Note that, the amplitude φ is assumed to be a fixed value regardless of the importance levels. It is possible to arbitrarily decide this value.

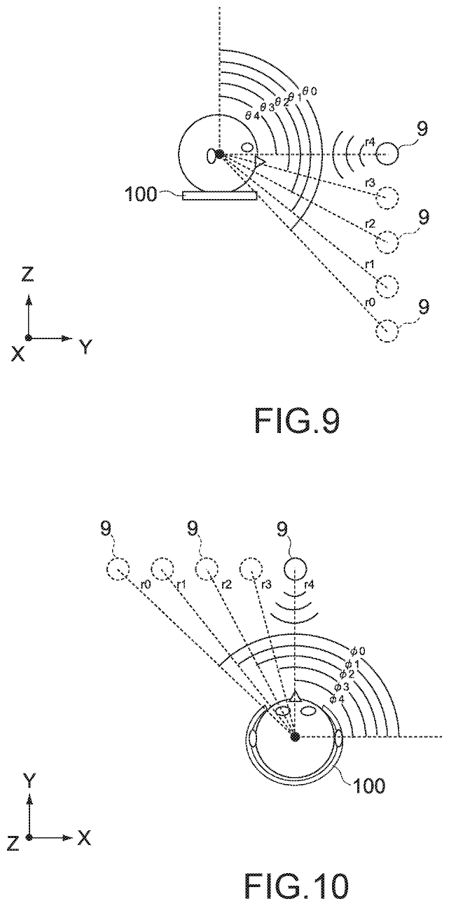

FIG. 9 is a diagram illustrating an example of a case of varying the radius r and the amplitude θ in accordance with the importance levels among the radius r, the amplitude θ, and the amplitude φ. In FIG. 9, the amplitude φ is set to 90°, and the radius r and the amplitude θ vary in front of the user.

In the case of varying the radius r and the amplitude θ, the radius r is set in such a manner that the radius r gets smaller as the importance level increases, for example. In addition, the amplitude θ is set in such a manner that the height of the sound image 9 gets closer to the height of the head of the user as the importance level increases. In this case, it is possible for the user to intuitively feel that the importance level is high. Note that, the relationship between the importance levels, the radius r, and the amplitude φ may be reversed.

In the example illustrated in FIG. 9, the radius r decreases in order of the radius r0, the radius r1, the radius r2, the radius r3, the radius r4. In addition, the height of the sound image 9 gets closer to the height of the center of the head in order of the amplitude θ0, the amplitude θ1, the amplitude θ2, the amplitude θ3, the amplitude θ4. In addition, the respective importance level 0 to importance level 4 are assigned to the radius r0 to the radius r4 and the amplitude θ0 to the amplitude θ4.

(Fifth Variation Method of Varying Radius r and Amplitude φ)

A fifth method of varying the sound image localization position is a method of varying the radius r and the amplitude φ in accordance with the importance levels among the radius r, the amplitude θ, and the amplitude φ in the spherical coordinate system. Note that, the amplitude θ is assumed to be a fixed value regardless of the importance levels. It is possible to arbitrarily decide this value.

FIG. 10 is a diagram illustrating an example of a case of varying the radius r and the amplitude φ in accordance with the importance levels among the radius r, the amplitude θ, and the amplitude φ. In FIG. 10, the amplitude θ is set to 90°, and the radius r and the amplitude φ vary at the position of the head of the user.

In the case of varying the radius r and the amplitude φ, the radius r is set in such a manner that the radius r gets smaller as the importance level increases, for example. In addition, the amplitude φ is set in such a manner that the position of the sound image 9 gets closer to the front side of the user as the importance level increases. Alternatively, the amplitude φ is set in such a manner that the position of the sound image 9 gets closer to the position of an ear of the user as the importance level increases. In this case, it is possible for the user to intuitively feel that the importance level is high. Note that, the relationship between the importance levels, the radius r, and the amplitude φ may be reversed.

In the example illustrated in FIG. 10, the radius r decreases in order of the radius r0, the radius r1, the radius r2, the radius r3, the radius r4. In addition, the position of the sound image 9 gets closer to the front side of the head in order of the amplitude φ0, the amplitude φ1, the amplitude φ2, the amplitude φ3, the amplitude φ4. In addition, the respective importance level 0 to importance level 4 are assigned to the radius r0 to the radius r4 and the amplitude φ0 to the amplitude φ4.

(Sixth Variation Method of Varying Amplitude θ and Amplitude φ)

A sixth method of varying the sound image localization position is a method of varying the amplitude θ and the amplitude φ in accordance with the importance levels among the radius r, the amplitude θ, and the amplitude φ in the spherical coordinate system. Note that, the radius r is assumed to be a fixed value regardless of the importance levels. It is possible to arbitrarily decide this values.

Here, the description will be given with reference to FIG. 7 and FIG. 8. For example, when the user is viewed from a lateral side, the sound image 9 is localized at the positions illustrated in FIG. 7. In addition, when the user is viewed from above, the sound image 9 is localized at the positions illustrated in FIG. 8.

In the case of varying the amplitude θ and the amplitude φ, the amplitude θ is set in such a manner that the height of the sound image 9 gets closer to the height of the head of the user as the importance level increases. In addition, the amplitude φ is set in such a manner that the position of the sound image 9 gets closer to the front side of the user as the importance level increases. Alternatively, the amplitude φ is set in such a manner that the position of the sound image 9 gets closer to the position of an ear of the user as the importance level increases. In this case, it is possible for the user to intuitively feel that the importance level is high. Note that, the relationship between the importance levels, the amplitude θ, and the amplitude φ may be reversed.

In FIG. 7 and FIG. 8, the height of the sound image 9 gets closer to the height of the center of the head in order of the amplitude θ0, the amplitude θ1, the amplitude θ2, the amplitude θ3, the amplitude φθ4. In addition, the position of the sound image 9 gets closer to the front side of the head in order of the amplitude φ0, the amplitude φ1, the amplitude φ2, the amplitude φ3, the amplitude φ4. In addition, the respective importance level 0 to importance level 4 are assigned to the amplitude θ0 to the amplitude θ4 and the amplitude θ0 to the amplitude φ4.

(Seventh Variation Method of Varying Radius r, the Amplitude θ, and Amplitude φ)

A seventh method of varying the sound image localization position is a method of varying all the radius r, the amplitude θ, and the amplitude φ in the spherical coordinate system in accordance with the importance levels.

Here, the description will be given with reference to FIG. 9 and FIG. 10. For example, when the user is viewed from a lateral side, the sound image 9 is localized at the positions illustrated in FIG. 9. In addition, when the user is viewed from above, the sound image 9 is localized at the positions illustrated in FIG. 10.

In the case of varying the radius r, the amplitude θ, and the amplitude φ, the radius r is set in such a manner that the radius r gets smaller as the importance level increases. In addition, the amplitude θ is set in such a manner that the height of the sound image 9 gets closer to the height of the head of the user as the importance level increases. In addition, the amplitude φ is set in such a manner that the position of the sound image 9 gets closer to the front side of the user as the importance level increases. Alternatively, the amplitude φ is set in such a manner that the position of the sound image 9 gets closer to the position of an ear of the user as the importance level increases. In this case, it is possible for the user to intuitively feel that the importance level is high. Note that, the relationship between the importance levels, the radius r, the amplitude θ, and the amplitude φ may be reversed.

(Eighth Variation Method of Varying Movement Speed of Sound Image 9)

An eighth method of varying the sound image localization position is a method of varying movement speed of the sound image 9 in accordance with the importance levels.

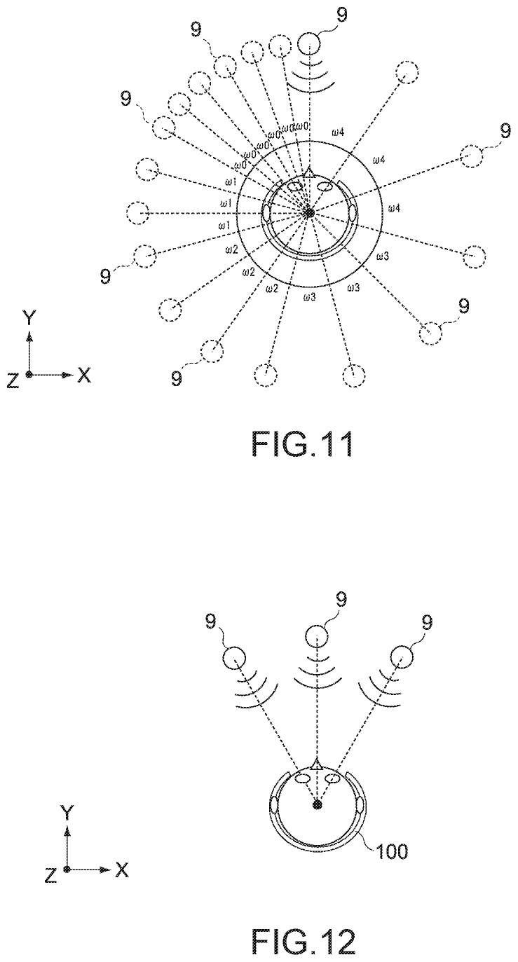

FIG. 11 is a diagram illustrating an example of a case of varying movement speed of the sound image 9 in accordance with the importance levels. FIG. 11 illustrates an example of a case where the sound image 9 is rotationally moved in the direction of the amplitude φ at speeds corresponding to the importance levels (note that, the radius r is fixed to a predetermined value, and the amplitude θ is fixed to 900).

In the case of varying the movement speed of the sound image 9, the movement speed is set in such a manner that the movement speed of the sound image 9 gets faster as the importance level increases, for example (in this case, the sound image 9 may stop when the importance level is low). Note that, conversely, it is also possible to set the movement speed in such a manner that the movement speed of the sound image 9 gets slower as the importance level increases (in this case, the sound image 9 may stop when the importance level is high).

In the example illustrated in FIG. 11, the sound image 9 moves rotationally in the direction of amplitude φ, and angular velocity increases in order of an angular velocity ω0, an angular velocity ω1, an angular velocity ω2, an angular velocity ω3, an angular velocity ω4. Next, the respective importance level 0 to importance level 4 are assigned to the angular velocity ω0 to the angular velocity ω4.

In the example illustrated in FIG. 11, the sound image 9 moves rotationally in the direction of amplitude φ. However, it is possible for the sound image 9 to move rotationally in the direction of amplitude θ, or move rotationally in both the direction of amplitude φ and the direction of amplitude θ. Typically, the movement pattern of the sound image 9 may be any movement pattern such as rotational movement, linear movement, or zigzag movement as long as the movement pattern is a constant and regular pattern.

Note that, it is possible to mutually combine the eighth variation method (of varying movement speed) with any one of the first to seventh variation methods described above. For example, if the eighth variation method is combined with the first variation method, the angular velocity ω in the direction of amplitude φ may be varied in accordance with the importance levels as illustrated in FIG. 11, and the radius r may be varied in accordance with the importance levels as illustrated in FIG. 5.

(Ninth Variation Method of Varying Number of Sound Images 9)

A ninth method of varying the sound image localization position is a method of varying the number of the sound images 9 in accordance with the importance levels.

FIG. 12 is a diagram illustrating an example of a case of varying the number of sound images 9 in accordance with the importance levels. FIG. 11 illustrates an example in which the number of sound images 9 is set to three in accordance with an importance level.

In the case of varying the number of sound images 9, the number of sound images 9 is varied in such a manner that the number of sound images 9 gets larger as the importance level increases, for example. In this case, it is possible for the user to intuitively feel that the importance level is high. Note that, conversely, it is also possible to reduce the number of sound images 9 as the importance level increases.

In the example illustrated in FIG. 12, only one sound image 9 is localized in front of the user when the importance level is 0, for example. When the importance level is 1 to 2, a left (or right) sound image 9 is added, and the total number of sound images 9 becomes two. When the importance level is 3 to 4, another right (or left) sound image 9 is added, and the total number of sound images 9 becomes three.

In addition, it is also possible to vary the localization positions of the sound images 9 in accordance with the importance levels in such a manner that the number of sound images 9 increases and an added sound image 9 moves in accordance with its importance level.

For example, with reference to FIG. 12, only one sound image 9 is localized in front of the user when the importance level is 0. Next, when the importance level is 1, the left sound image 9 and the right sound image 9 are added, and the total number of sound images 9 becomes three.

Next, when the importance level is 2, angles of the left sound image 9 and the right sound image 9 with respect to the front side in the direction of amplitude φ are set to be larger than the case where the importance level is 1. In a similar way, when the importance level is 3, the angles are set to be larger than the case where the importance level is 2. In addition, when the importance level is 4, the angles are set to be larger than the case where the importance level is 3. The sound image 9 is closest to the ear when the importance level is 4.

With reference to FIG. 12, the case where the number of sound images 9 is up to three has been described above. However, the number of sound images 9 is not limited. The number of sound images 9 may be up to two, or may be four or more. In addition, with reference to FIG. 12, the case where the number of sound images 9 increases in the direction of amplitude φ has been described. However, the sound image 9 may be added at any position in a three-dimensional space.

Note that, it is possible to mutually combine the ninth variation method (of varying the number) with any one of the first to eighth variation methods described above. For example, if the ninth variation method is combined with the first variation method, the number of sound images 9 may be varied in accordance with the importance levels as illustrated in FIG. 12, and the radius r may be varied in accordance with the importance levels as illustrated in FIG. 5.

<Workings, etc.>

As described above, the wearable device 100 according to the present embodiment determines importance levels of respective pieces of text data, and varies a localization position of the sound image 9 with respect to the user in accordance with the importance levels. The sound image 9 outputs voice for reading aloud the text data.

This makes it possible to emphasize a piece of the text data, which is important for the user, when the sound image 9 outputs the voice for reading aloud the text data. Therefore, it is possible to easily impress on the user the important piece of the text data. In addition, this makes it possible to improve reliability and favorability of the voice (voice agent)

In addition, it is possible to more easily impress on the user the important piece of the text data when the radius r (the distance r between the user and the sound image 9) varies in the spherical coordinate system in accordance with the importance levels. In particular, it is possible to more appropriately emphasize the piece of the text data, which is important for the user, by reducing the distance r (the radius r) as the importance level increases. This makes it possible to more easily impress on the user the important piece of the text data.

In addition, it is possible to more easily impress on the user the important piece of the text data when the amplitude θ (the height of the sound image 9 relative to the user) varies in the spherical coordinate system in accordance with the importance levels. In particular, it is possible to more appropriately emphasize the piece of the text data, which is important for the user, by varying the amplitude θ in such a manner that the sound image 9 gets closer to the height of the head of the user as the importance level increases. This makes it possible to more easily impress on the user the important piece of the text data.

In addition, it is possible to more easily impress on the user the important piece of the text data when the amplitude φ varies in the spherical coordinate system in accordance with the importance levels. In particular, it is possible to more appropriately emphasize the piece of the text data, which is important for the user, by varying the amplitude φ in such a manner that the sound image 9 gets closer to the front side of the user as the importance level increases. This makes it possible to more easily impress on the user the important piece of the text data. In addition, it is possible to more appropriately emphasize the piece of the text data, which is important for the user, by varying the amplitude φ in such a manner that the sound image 9 gets closer to an ear of the user as the importance level increases. This makes it possible to more easily impress on the user the important piece of the text data.

In addition, it is possible to more appropriately emphasize the piece of the text data, which is important for the user, by varying the movement speed of the sound image 9 in accordance with the importance levels. This makes it possible to more easily impress on the user the important piece of the text data.

In addition, it is possible to more easily impress on the user the important piece of the text data when the number of sound images 9 varies in accordance with the importance levels. In particular, it is possible to more appropriately emphasize the piece of the text data, which is important for the user, by increasing the number of sound images 9 as the importance level increases. This makes it more easily possible to impress on the user the important piece of the text data.

Here, according to the present embodiment, the present technology is applied to the neckband-type wearable device 100. The neckband-type wearable device 100 is used while being worn on a body part of the user, which the user cannot see. Therefore, the neckband-type wearable device 100 does not include a display section in general, and information is mainly provided to the user by voice.

In the case of a device including the display section, it is possible to notify the user which piece of text data is important by displaying the text data on a screen and indicating the important piece of the text data by boldface, or changing the font of the important piece of the text data.

However, the neckband-type wearable device 100 mainly provides information to the user by voice as described above. Therefore, it is not so easy for the neckband-type wearable device 100 to emphasize the important piece of the text data.

However, according to the present embodiment, it is possible to vary the localization position of the sound image 9 in accordance with the importance levels. Therefore, it is possible to easily impress on the user the important piece of the text data even in the case of a device that mainly provides information by voice, such as the neckband-type wearable device.

In other words, the present technology is more effective when the present technology is applied to the device (such as headphones, or a stationary speaker 7, for example) that does not include the display section but that mainly provides information by voice such as the neckband-type wearable device.

However, this does not mean that it is impossible to apply the present technology to the device that includes the display section. The present technology is also applicable to the device including the display section.

<Modification of First Embodiment>

“Habituation Prevention”

The control section 1 may execute the following process [1] or [2] to prevent the user from getting used to variation in the localization position of the sound image 9 based on the importance levels.

[1] Any one of a plurality of preliminarily prepared variation patterns (see the first to ninth variation method described above) of the localization position of the sound image 9 is selected, and the localization position of the sound image 9 is varied on the basis of the selected variation pattern.

(a) For example, any one of the plurality of variation patterns may be selected each time a predetermined period of time elapses after usage of the wearable device 100 starts. Subsequently, the localization position of the sound image 9 may be varied on the basis of the selected variation pattern.

(b) Alternatively, any one of the plurality of variation patterns may be selected for each application such as email, news, or navigation. Subsequently, the localization position of the sound image 9 may be varied on the basis of the selected variation pattern.

(c) Alternatively, any one of the plurality of variation patterns may be selected in response to behavior of the user (such as sleeping, sitting, walking, running, or being in a vehicle). Subsequently, the localization position of the sound image 9 may be varied on the basis of the selected variation pattern. It is possible to determine the behavior of the user on the basis of detection values detected by various kinds of sensors such as the angular velocity sensor 3, the acceleration sensor 4, the geomagnetic sensor 5, and the GPS 6. Note that, it is also possible for the wearable device 100 to include an imaging section to improve accuracy of the behavior recognition.

[2] The magnitude of variation in the localization position of the sound image 9 relative to a criterion (such as the radius r0, the amplitude θ0, the amplitude φ0, or the angular velocity ω0 corresponding to the importance level 0) may be varied over time.

(a)′ For example, the magnitude of variation in the localization position of the sound image 9 based on the importance levels relative to the criterion may be varied each time a predetermined period of time elapses after usage of the wearable device 100 starts. In other words, even in the case where the importance level is not changed, the magnitude of variation in the localization position of the sound image 9 relative to the criterion is varied over time.

For example, with reference to FIG. 5, a difference (|r1−r0|) between the radius r0 and the radius r1, a difference (|r2−r0|) between the radius r0 and the radius r2, a difference (|r3−r0|) between the radius r0 and the radius r3, and a difference (|r4−r0|) between the radius r0 and the radius r4 increase over time while using the radius r0 as the criterion (typically, the radius r0 is fixed). In other words, in the example illustrated in FIG. 5, the radius r1 to the radius r4 get smaller over time. In this case, the positions of the sound image 9 corresponding to the radius r1 to the radius r4 get closer to the user over time. In addition, for example, with reference to FIG. 7, a difference (|θ1−θ0|) between the amplitude θ0 and the amplitude θ1, a difference (|θ2−θ0|) between the amplitude θ0 and the amplitude θ2, a difference (|θ3−θ0|) between the amplitude θ0 and the amplitude θ3, and a difference (|θ4−θ0|) between the amplitude θ0 and the amplitude θ4 increase over time while using the amplitude θ0 as the criterion (typically, the amplitude θ0 is fixed). In other words, in the example illustrated in FIG. 7, the amplitude θ1 to the amplitude θ4 get smaller over time. For example, at first, the heights of the sound image 9 corresponding to the amplitude θ1 to the amplitude 04 are set to be lower than the positions illustrated in FIG. 7. Subsequently, the heights of the sound image 9 get closer to the positions illustrated in FIG. 7 over time.

In addition, for example, with reference to FIG. 8, a difference (|φ1−φ0|) between the amplitude φ0 and the amplitude φ1, a difference (|φ2−φ0|) between the amplitude φ0 and the amplitude φ2, a difference (|φ3−φ0|) between the amplitude φ0 and the amplitude φ3, and a difference (|φ4−φ0|) between the amplitude φ0 and the amplitude φ4 increase over time while using the amplitude φ0 as the criterion (typically, the amplitude φ0 is fixed). In other words, in the example illustrated in FIG. 8, the amplitude φ1 to the amplitude φ⁴ get smaller over time. For example, at first, the positions of the sound image 9 corresponding to the amplitude φ1 to the amplitude φ4 are set to be on the left side of the positions illustrated in FIG. 8. Subsequently, the positions of the sound image 9 get closer to the positions illustrated in FIG. 8 over time. In addition, for example, with reference to FIG. 11, a difference (|ω1−ω0|) between the angular velocity ω0 and the angular velocity ω1, a difference (|ω2−ω0|) between the angular velocity ω0 and the angular velocity ω2, a difference (|ω3−ω0|) between the angular velocity ω0 and the angular velocity ω3, and a difference (|ω4−ω0|) between the angular velocity ω0 and the angular velocity ω4 increase over time while using the angular velocity ω0 as the criterion (typically, the angular velocity ω0 is fixed). In other words, in the example illustrated in FIG. 11, the angular velocity ω1 to the angular velocity ω4 get larger over time, and the angular velocity of the sound image 9 gets faster.

Through the process [1] or [2], it is possible to appropriately prevent the user from getting used to variation in the localization position of the sound image 9. Note that, it is also possible to combine two or more selected from among (a) to (c) and (a)′ described above.

“Method Other than Varying Sound Image Localization Position”

In addition to the process of varying the localization position of the sound image 9 in accordance with the importance levels, the control section 1 may execute the following process [1] or [2] to more easily impress on the user an important piece of text data.

[1] Method of Varying Sound Output from Sound Image 9 in accordance with Importance Levels

(a) For example, it is possible to vary sound volume in accordance with the importance levels. In this case, typically, the sound volume gets larger as the importance level increases. (b) Alternatively, it is also possible to emphasize a specific frequency band (such as a low frequency band or a high frequency band) in accordance with the importance levels through equalization. (c) Alternatively, it is also possible to change speed of reading aloud text data in accordance with the importance levels. In this case, typically, the speed gets slower as the importance level increases.

(d) Alternatively, it is possible to change a tone of voice (such as voice of a same person, or voices of completely different people (like male and female)) in accordance with the importance levels. In this case, typically, a more impressive tone of voice is used as the importance level increases. (e) It is possible to add sound effects in accordance with the importance levels. In this case, a more impressive sound effect is added as the importance level increases.

[2] Method of Varying Element Other than Sound in accordance with Importance Levels (Method of Stimulating Sense of Smell, Sense of Touch, or Sense of Vision)

(a)′ For example, it is possible to change aroma in accordance with the importance levels. In this case, the wearable device 100 includes an aroma generation section that generates aroma. Typically, the aroma generation section generates more impressive aroma as the importance level increases.

(b)′ Alternatively, it is possible to change vibration in accordance with the importance levels. In this case, the wearable device 100 includes a vibration section that generates vibration. Typically, the vibration is changed in such a manner that the vibration gets stronger as the importance level increases. (c)′ Alternatively, it is possible to change a blinking pattern of light in accordance with the importance levels. In this case, the wearable device 100 includes a light generation section that generates light. Typically, the blinking pattern of light is changed in such a manner that the light blinking speed gets faster as the importance level increases.

The process [1] or [2] makes it possible to more easily impress on the user the important piece of the text data. Note that, with regard to the process [2], the wearable device 100 according to the present embodiment is worn on a body part near a nose or eyes. Therefore, emphasis using the aroma or the light is effective. In addition, emphasis using the vibration is also effective because the wearable device 100 is worn on the neck.

Note that, it is also possible to combine two or more selected from among (a) to (e) and (a)′ to (c)′

### Second Embodiment

Next, a second embodiment of the present technology will be described. In the description related to the second embodiment, structures that are similar to those in the first embodiment will be denoted by the same reference signs as the first embodiment, and description thereof will be omitted or simplified.

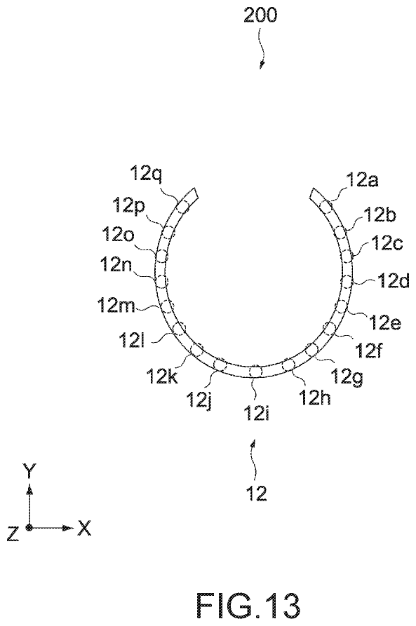

FIG. 13 is a top view of a wearable device 200 according to the second embodiment. The wearable device 200 according to the second embodiment is different from the above-described first embodiment in that a plurality of vibration sections 12 is provided around the entire circumference of the wearable device 200.

Each of the vibration sections 12a to 12q includes an eccentric motor, a voice coil motor, or the like, for example. In the example illustrated in FIG. 13, the number of vibration sections 12 is 17. However, the number of vibration sections 12 is not specifically limited.

Note that, typically, it is sufficient for the wearable device 100 to include the two or more vibration sections 12 (a first vibration section located in a first direction relative to the user and a second vibration section located in a second direction relative to the user) at different positions in a circumferential direction (p direction).

<Description of Operation>

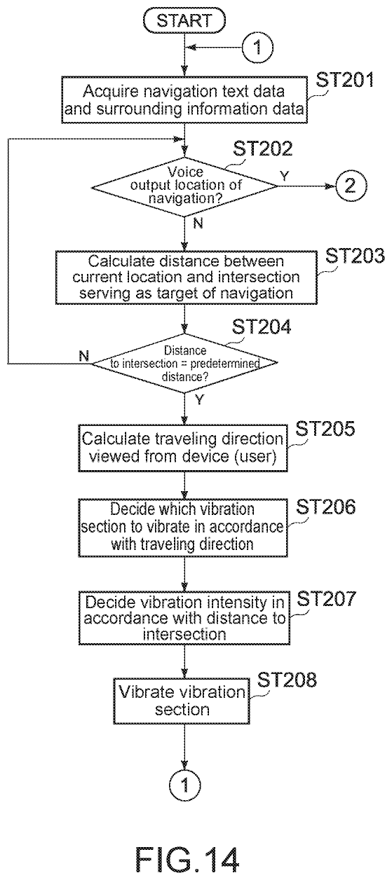

Next, processes performed by the control section 1 will be described. FIG. 14 to FIG. 16 are flowcharts illustrating processes performed by the control section 1.

First, the control section 1 acquires navigation text data and surrounding road data from a server apparatus on a network on a predetermined cycle (Step 201).

Here, according to the second embodiment, the navigation text data includes at least information indicating a traveling direction that the user should follow (such as go straight, turn right, turn left, take a slight right, or take a slight left) at a certain location (an intersection) indicated by navigation.

For example, the navigation text data may be text data such as “after 500 meters, turn right”, “after 50 meters, turn left”, “after 1 km, go straight”, “after 1 km, take a slight left”, or “after 1 km, take a slight right”.

In addition, sometimes the navigation text data may include information regarding a road condition (such as a traffic jam, a slope, a curve, road work ahead, a bumpy road, or a gravel road) related to a location ahead of the traveling direction. For example, after the sentence “after 500 meters, turn right” or the like, the navigation text data may sometimes include information such as “then you will hit a 10-km-long traffic jam”, “then you will hit a 500-meters-long traffic jam”, “then you will hit gentle slopes”, “then you will hit steep slopes”, or “then you will hit a sharp right-hand curve”.

Note that, the text data related to the road conditions does not have to be included in advance in the navigation text data acquired from the server apparatus. The control section 1 may generate such text data related to the road conditions on the basis of road condition information (which is not text data) acquired from the server apparatus.

Road surrounding data is various kinds of data (which is not text data) such as shops, facilities, natural things (such as mountains, livers, waterfalls, and oceans), and tourist attractions around the location (the intersection) indicated by the navigation.

After necessary data is acquired, the control section 1 then determines whether a current location is a voice output location of the navigation (Step 202). For example, in the case where the voice “after 500 meters, turn right” is output, the control section 1 determines whether the current location is a location that is 500 meters behind the location (the intersection) indicated by the navigation, on the basis of GPS information.

In the case where the current location is not the voice output location of the navigation (No in Step 202), the control section 1 calculates a distance from the current location to the location (the intersection) indicated by the navigation on the basis of the GPS information (Step 203).

Next, the control section 1 determines whether the distance from the current location to the location (the intersection) indicated by the navigation is a predetermined distance (Step 204).

For example, the predetermined distance serving as a comparison target is set to a 200-meter interval, a 100-meter interval, a 50-meter interval, or the like. The predetermined distance may be set in such a manner that the interval gets shorter as the distance to the location (the intersection) indicated by the navigation decreases.

In the case where the distance to the location (the intersection) indicated by the navigation is not the predetermined distance (No in Step 204), the control section 1 returns to Step 202 and determines again whether a current location is the voice output location of the navigation.

On the other hand, in the case where the distance to the location (the intersection) indicated by the navigation is the predetermined distance (Yes in Step 204), the control section 1 proceeds to next Step 205.

Here, details of the case of satisfying conditions that the current location is not the voice output location of the navigation but the distance from the current location to the location (the intersection) indicated by the navigation is the predetermined distance (Yes in Step 204), will be described with reference to an example.

It is assumed that the voice output location of the navigation is set to 500 meters, 300 meters, 100 meters, 50 meters before the intersection. In addition, it is assumed that the predetermined distance serving as the comparison target is set to 500 meters, 450 meters, 400 meters, 350 meters, 300 meters, 250 meters, 200 meters, 150 meters, 100 meters, 70 meters, 50 meters, or 30 meters.

When the user is located at a position that is 500 meters, 300 meters, 100 meters, or 50 meters before the intersection, this position is identical to the voice output location of the navigation (Yes in Step 202). Therefore, this situation does not satisfy the above-described conditions. In this case, as described later, the speakers 7 outputs the voice “After 500 meters, turn right. Then you will hit a 1-km-long traffic jam” or the like.

On the other hand, when the user is located at a position that is 450 meters, 400 meters, 350 meters, 250 meters, 200 meters, 150 meters, 70 meters, or 30 meters before the intersection, this position is not identical to the voice output location of the navigation. In addition, the distance to the location (the intersection) indicated by the navigation is identical to the predetermined distance. Therefore, this situation satisfies the above-described conditions. Accordingly, the control section 1 proceeds to Step 205.

In Step 205, the control section 1 calculates a traveling direction viewed from the wearable device 100 (the user) on the basis of the detection values detected by the various kinds of sensors including the geomagnetic sensor 5 and the like, and information regarding the traveling direction that the user should follow (such as “turn right”, for example), the information being included in the navigation text data.

Next, the control section 1 decides which of the plurality of vibration sections 12 to vibrate in accordance with the traveling direction viewed from the wearable device 100 (the user) (Step 206).

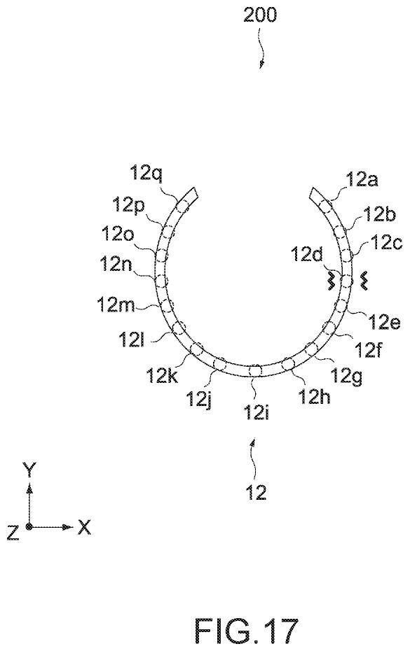

For example, in the case where the traveling direction that the user should follow is a right direction, a vibration section 12 located in the right direction relative to the user is decided as the vibration section 12 to vibrate. FIG. 17 is a diagram illustrating a situation where the vibration section 12d located on the right side of the user is being vibrated.

Note that, for example, in the case where the traveling direction that the user should follow is a left direction, a right diagonal direction, or a left diagonal direction, a vibration section 12 located in the left direction, the right diagonal direction, or the left diagonal direction relative to the user is decided as the vibration section 12 to vibrate.

Note that, the wearable device 100 has the opened portion located on the front side of the user. Therefore, in the case where the traveling direction that the user should follow is a straight direction, there is no vibration section 12 corresponding to the straight direction. Accordingly, in this case, the two vibration sections 12a and 12q located at front ends of the wearable device 100 may be decided as the vibration sections 12 to vibrate.

Note that, in the case of deciding a vibration section 12 corresponding to the traveling direction that the user should follow, two or more adjacent vibration sections 12 may be decided as the vibration sections 12 to vibrate. For example, in the case where the traveling direction that the user should follow is the right direction, the vibration section 12d located in the right direction relative to the user and two vibration sections 12c and 12e that are adjacent to the vibration section 12d (that is, the three vibration sections in total) may be decided as the vibration sections 12 to vibrate.

After the vibration section 12 to vibrate is decided, the control section 1 then decides vibration intensity of the vibration section 12 in accordance with a distance to the location (the intersection) indicated by the navigation (Step 207). In this case, the control section 1 typically decides the vibration intensity of the vibration section 12 in such a manner that the intensity of the vibration gets stronger as the distance to the location (the intersection) indicated by the navigation decreases.

Next, the control section 1 vibrates the vibration section 12 to vibrate with the decided vibration intensity (Step 208), and then returns to Step 201 again.

Accordingly, for example, when the user is located at a position that is 450 meters, 400 meters, 350 meters, 250 meters, 200 meters, 150 meters, 70 meters, or 30 meters before the intersection, the vibration section 12 corresponding to the traveling direction that the user should follow vibrates with intensity corresponding to the distance to the intersection (the intensity increases as the distance gets shorter).

Note that, as understood from the above description, according to the second embodiment, the vibration section 12 corresponding to the traveling direction vibrates at a timing (such as at a location that is 450 meters, 400 meters, or the like before the intersection) other than a timing of reading aloud the text data including the traveling direction that the user should follow.

This is because, according to the present embodiment, sometimes the vibration section 12 vibrates to notify of presence of information that is beneficial to the user such as a road condition. This makes it possible to prevent the user from confusing the vibration indicating presence of beneficial information and vibration indicating a direction that the user should follow. Details thereof will be described later.

Note that, it is also possible to vibrate the vibration section 12 corresponding to the traveling direction in conformity with the timing of reading aloud the text data including the traveling direction that the user should follow (for example, at the location that is 500 meters, 300 meters, 100 meters, or 50 meters before the intersection). In other words, it is sufficient to vibrate the vibration section 12 corresponding to the traveling direction at least at a timing other than the timing of reading aloud the traveling direction that the user should follow.

In addition, in this example, the case where the vibration section 12 corresponding to the traveling direction vibrates in accordance with the respective predetermined distances has been described. However, it is also possible to vibrate the vibration section 12 corresponding to the traveling direction at predetermined time intervals.

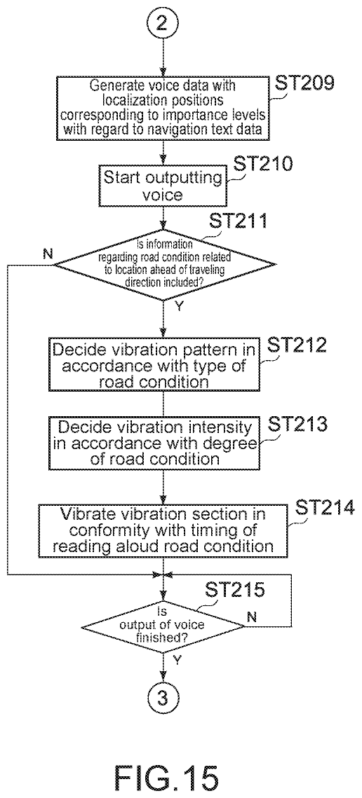

In the case where the current location is the voice output location of the navigation in Step 202 (Yes in Step 202), the control section 1 proceeds to next Step 209 (see FIG. 15). For example, the control section 1 proceeds to Step 209 when the user is located at a position that is 500 meters, 300 meters, 100 meters, or 50 meters before the intersection.

In Step 209, the control section 1 generates voice data with the localization positions corresponding to the importance levels with regard to the navigation text data. With regard to the control over the localization position of the sound image 9 according to the importance levels, the description thereof is similar to that of the first embodiment described above.

Note that, with regard to the control over the localization position of the sound image 9, it is also possible to vary the amplitude φ in accordance with information indicating the traveling direction. For example, in the case where the navigation text data includes words such as turn right, turn left, go straight, take a slight right, or take a slight left, the control section 1 may vary the amplitude φ in such a manner that the sound image 9 is localized in a direction corresponding to the words. In this case, the radius r and the amplitude θ are varied to represent variation in the localization position of the sound image 9 depending on the importance levels.

After the voice data with the localization positions is generated, the control section 1 then starts outputting voice data with the localization positions (Step 210).

This makes it possible to start outputting voice such as “After 500 meters, turn right” or “After 500 meters, turn right. Then you will hit a 1-km-long traffic jam”.

Next, the control section 1 determines whether the navigation text data includes information regarding a road condition related to a location ahead of the traveling direction. At this time, for example, the control section 1 determines that the navigation text data includes the information regarding a road condition related to the location ahead of the traveling direction, in the case where a word that comes after the words “Then you will hit a” is a word that matches any one word included in the preliminarily stored character strings (such as traffic jam and steep slope) related to road conditions.

The control section 1 proceeds to Step 215 in the case where the navigation text data does not include the information regarding a road condition related to the location ahead of the traveling direction (No in Step 211). For example, the control section 1 proceeds to Step 215 in the case where the navigation text data is text data that includes no road condition such as the sentence “After 500 meters, turn right”.

On the other hand, the control section 1 proceeds to Step 212 in the case where the navigation text data includes the information regarding a road condition related to the location ahead of the traveling direction (Yes in Step 211). For example, the control section 1 proceeds to Step 212 in the case where the navigation text data is text data that includes a road condition such as the sentence “After 500 meters, turn right. Then you will hit a 1-km-long traffic jam”.

In Step 212, the control section 1 decides a vibration pattern in accordance with the type of the road condition. Examples of the type of the road condition include a traffic jam, a slope, a curve, road work ahead, a situation of the road (such as a bumpy road or a gravel road), and the like. The vibration pattern is stored in advance in the storage section 2 in association with the type of the road condition. Note that, the vibration pattern includes a pattern indicating which vibration section 12 to vibrate, a pattern indicating a vibration direction of the vibration section 12, or the like.

Next, vibration intensity of the vibration section 12 is decided in accordance with a degree of the road condition (Step 213). In this case, the control section 1 determines the degree of the road condition on the basis of a numerical value that comes before a word related to the road condition (such as a numerical digit like “1 km” before the words “traffic jam”) or an adjective included in words related to the road condition (such as a word “steep” included in words “steep slope”) in the navigation text data.

Next, the control section 1 decides the vibration intensity related to the road condition in such a manner that the vibration gets stronger as the degree of the road condition gets worse (a traffic jam becomes longer, a slope becomes more steep, a curve becomes sharper, or a road work distance becomes longer). Note that, it is also possible for the control section 1 to select a more irregular vibration pattern as the degree of the road condition gets worse (for example, the vibration section 12 to vibrate is fixed in the case where the degree is not so bad, but the vibration section 12 to vibrate is randomly decided in the case where the degree of the road condition is bad)

Next, the control section 1 vibrates the vibration section 12 with the decided vibration pattern and the decided vibration intensity in conformity with the timing of reading aloud the road condition (for example, at a location that is 500 meters, 300 meters, or 50 meters before the intersection). The vibration section 12 is vibrated while the sentence “After 500 meters, turn right. Then you will hit a 1-km-long traffic jam” is read aloud by voice, for example. Note that, at this time, it is possible to set the vibration intensity in such a manner that the maximum vibration intensity is obtained at a timing of reading aloud words indicating the road condition such as “1-km-long traffic jam”.

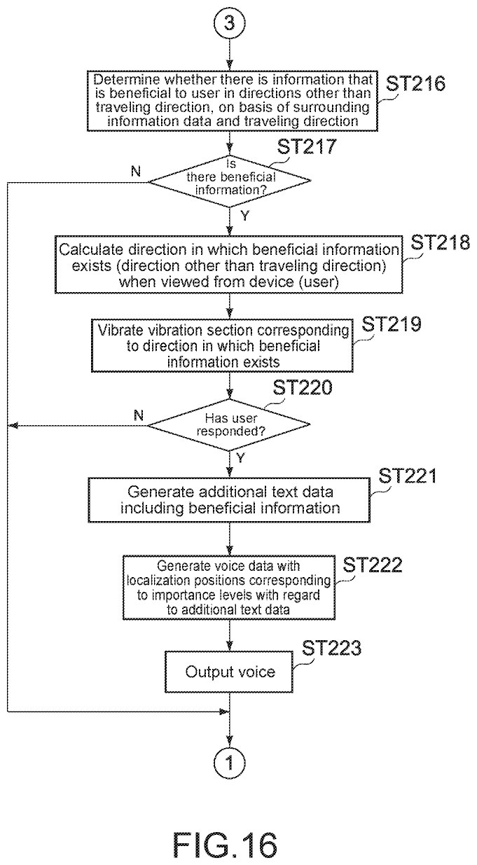

After the vibration section 12 is vibrated, the control section 1 then determines whether output of voice of the navigation text data is finished (Step 215). The control section 1 proceeds to next Step 216 (see FIG. 16) in the case where the output of the voice is finished (Yes in Step 215).

In Step 216, the control section 1 determines whether there is information that is beneficial to the user (information related to locations ahead of directions other than the traveling direction) in the directions other than the traveling direction, on the basis of the surrounding information data and the traveling direction that the user should follow.

At this time, it is possible to refer to the user information including the information regarding the user's favorite things and the information regarding degrees of favorability thereof. Note that, examples of the information that is beneficial to the user include the user's favorite things (such as scenery or ramen restaurants), tourist attractions, well-known stores, well-known facilities, and the like.

In the case where there is no information that is beneficial to the user (No in Step 217), the control section 1 returns to Step 201 (see FIG. 14), and executes the processes in Step 201 and subsequent steps again.

As an example, it is assumed that the traveling direction that the user should follow is the right direction, but a ramen restaurant is in the left direction, for example (the presence of the ramen restaurant and its location are acquired from the surrounding information data). In addition, it is assumed that the ramen restaurant is registered as a user's favorite thing.

In this case, the control section 1 determines that there is information that is beneficial to the user (such as the ramen restaurant) (Yes in Step 217), and proceeds to next Step 218.

In Step 218, the control section 1 calculates a direction in which the beneficial information exists when viewed from the wearable device 100 (a direction other than the traveling direction that the user should follow (such as the left direction)), on the basis of the detection values detected by the various sensors and information regarding the traveling direction that the user should follow (such as the right direction).

Next, the control section 1 vibrates a vibration section 12 corresponding to the direction (such as the left direction) in which the beneficial information exists (Step 219). This makes it possible to notify the user that the information beneficial to the user (such as the ramen restaurant) exists in the direction (such as the left direction) other than the traveling direction (such as the right direction).

Next, the control section 1 determines whether the user has responded to the vibration of the vibration section 12 within a predetermined period of time (such as several seconds) after the vibration of the vibration section 12 (Step 220). According to the second embodiment, it is determined whether the user has responded, on the basis of whether the user has tilted his/her neck toward the direction of the vibrated vibration section 12 (this determination can be made by a sensor such as the angular velocity sensor 3).

Note that, the response from the user to the vibration is not limited to the tilting of the user's neck. For example, the user may respond to the vibration by touching the wearable device 100 (in this case, the wearable device 100 also includes an operation section that detects the touch operation), or the user may respond to the vibration by voice (in this case, the wearable device 100 may include a microphone that detects the voice).

In the case where the user has not responded within the predetermined period of time (such as several seconds) after the vibration of the vibration section 12 (No in Step 220), the control section 1 returns to Step 201 and executes the processes in Step 201 and subsequent steps again.

In the case where the user has responded within the predetermined period of time (such as several seconds) after the vibration of the vibration section 12 (Yes in Step 220), the control section 1 generates additional text data including the beneficial information (Step 221).

Examples of the additional text data include a sentence “Turn left, and a ramen restaurant will be seen”, a sentence “If you do not turn right but go straight, beautiful scenery will be seen”, a sentence “Turn right, and an Italian restaurant will be seen”, and other sentences.

Next, the control section 1 generates voice data with the localization positions corresponding to the importance levels with regard to the additional text data (Step 222). With regard to the control over the localization position of the sound image 9 according to the importance levels, the description thereof is similar to that of the first embodiment described above.

Note that, with regard to the control over the localization position of the sound image 9, it is also possible to vary the amplitude φ in accordance with information indicating the direction other than the traveling direction that the user should follow (such as the word “right” in the sentence “turn right” or the words “go straight” in the sentence “if you do not turn right but go straight”). For example, in the case where the additional text data includes a word related to a direction other than the traveling direction that the user should follow, the control section 1 may vary the amplitude φ in such a manner that the sound image 9 is localized in the direction corresponding to the word. In this case, the radius r and the amplitude θ are varied to represent variation in the localization position of the sound image 9 depending on the importance levels.

After the voice data with the localization positions is generated, the control section 1 then outputs the generated voice data (Step 223). This makes it possible for the speakers 7 to output voice such as “Turn left, and a ramen restaurant will be seen”, “If you do not turn left but go straight, beautiful scenery will be seen”, “Turn right, and an Italian restaurant will be seen”, or the like.

After the voice data is output, the control section 1 returns to Step 201 and executes the processes in Step 201 and subsequent steps again.

Step 216 to Step 223 will be simply described in chronological order. For example, the left vibration section 12 that is opposite to the traveling direction vibrates immediately after the voice “After 500 meters, turn right” is reproduced (the voice “Then you will hit a 1-km-long traffic jam” or the like is added in the case where there is information regarding a road condition).

In other words, the vibration section 12 corresponding to the direction other than the traveling direction vibrates in conformity with the timing of reading aloud the traveling direction that the user should follow such as “turn right” (for example, at the location that is 500 meters, 300 meters, 100 meters, or 50 meters before the intersection).

When the user expects something in the left direction and tilts his/her neck toward the left direction in response to the vibration, the voice “Turn left, and a ramen restaurant will be seen” is reproduced. This voice is not reproduced when the user does not tilt his/her neck toward the left (when the user ignores the vibration).

<Workings, etc.>

According to the second embodiment, it is possible for the user to intuitively recognize the traveling direction because the vibration section 12 corresponding to the traveling direction that the user should follow vibrates. In addition, at this time, the vibration section 12 vibrates with intensity corresponding to the distance to the location (the intersection) indicated by the navigation (the intensity gets stronger as the distance decreases). This makes it possible for the user to intuitively recognize the distance to the location (the intersection) indicated by the navigation.

In addition, the vibration section 12 corresponding to the traveling direction is vibrated at a timing other than the timing of reading aloud the traveling direction that the user should follow. This prevents the user from confusing vibration related to the traveling direction, vibration indicating presence of beneficial information related to the direction other than the traveling direction, and vibration based on road information regarding a location ahead of the traveling direction.

In addition, according to the second embodiment, the vibration section 12 vibrates in conformity with a timing of reading aloud the road information related to the location ahead of the traveling direction. This makes it possible for the user to intuitively recognize that a road condition of the location ahead of the traveling direction is not as usual.

In addition, at this time, the vibration section 12 vibrates with different vibration patterns corresponding to types of road conditions. This makes it possible for the user to intuitively recognize the types of road conditions by getting used to using the wearable device 100 and memorizing the vibration patterns. In addition, when the user has gotten used to using the wearable device 100 and has memorized the vibration patterns, it is also possible to omit the process of reading aloud the road information regarding the location ahead of the traveling direction but notify the user of the road condition by using the vibration pattern only. In this case, it is possible to reduce time taken to read aloud the text data. In addition, according to the second embodiment, it is possible for the user to intuitively recognize the degree of the road condition because vibration intensity varies in accordance with the degrees of the road condition.

In addition, according to the second embodiment, the vibration section 12 corresponding to the direction other than the traveling direction vibrates in conformity with the timing of reading aloud the traveling direction that the user should follow. This makes it possible for the user to recognize that there is information beneficial to the user in the direction other than the traveling direction.

In addition, when the user has responded to the vibration, voice for reading aloud the beneficial information is reproduced. On the other and, when the user has not responded to the vibration, voice for reading aloud the beneficial information is not reproduced. In other words, the user is capable of voluntarily select whether to listen to the beneficial information. This prevents the user from feeling that it is bothersome when beneficial information is read aloud each time there is beneficial information or when voice for reading aloud the beneficial information is long.

<<Various Modifications>>

In the above description, the neckband-type wearable device 100 has been used as an example of the information processing apparatus. However, the information processing apparatus is not limited thereto. For example, the information processing apparatus may be a wearable device other than the neckband-type wearable device such as a wristband wearable device, a glasses-type wearable device, a ring-like wearable device, or a belt-like wearable device.

In addition, the information processing apparatus is not limited to the wearable device 100. The information processing apparatus may be a mobile phone (including a smartphone), a personal computer (PC), headphones, a stationary speaker, or the like. Typically, the information processing apparatus may be any device as long as the device is capable of executing a process related to sound (in addition, the device that performs the process does not have to include the speaker 7 therein). In addition, the above-described processes performed by the control section 1 may be executed by a server apparatus (an information processing apparatus) on a network.

The present technology may also be configured as below.

(1) An information processing apparatus including:

a control section that analyzes text data, determines importance levels of respective pieces of the text data, and varies a localization position of a sound image of speech voice of the text data with respect to a user in accordance with the importance levels.

(2) The information processing apparatus according to (1),

in which the control section varies the localization position of the sound image in such a manner that a distance r of the sound image with respect to the user varies in a spherical coordinate system in accordance with the importance levels.

(3) The information processing apparatus according to (1) or (2),

in which the control section varies the localization position of the sound image in such a manner that an amplitude θ of the sound image with respect to the user varies in a spherical coordinate system in accordance with the importance levels.

(4) The information processing apparatus according to any one of (1) to (3),

in which the control section varies the localization position of the sound image in such a manner that an amplitude φ of the sound image with respect to the user varies in a spherical coordinate system in accordance with the importance levels.

(5) The information processing apparatus according to any one of (1) to (4),

in which the control section is capable of moving the sound image at a predetermined speed, and varies the speed in accordance with the importance levels.

(6) The information processing apparatus according to any one of (1) to (5),

in which the control section varies the number of sound images in accordance with the importance levels.

(7) The information processing apparatus according to any one of (1) to (6),

in which the control section varies sound to be output from the sound image in accordance with the importance levels.

(8) The information processing apparatus according to any one of (1) to (7), including

at least one of an aroma generation section that generates aroma, a vibration section that generates vibration, or a light generation section that generates light,

in which the control section varies at least one of the aroma, the vibration, or the light in accordance with the importance levels.

(9) The information processing apparatus according to any one of (1) to (8),

in which the control section selects any one of a plurality of preliminarily prepared variation patterns of the localization position of the sound image, and varies the localization position of the sound image on the basis of the selected variation pattern.

(10) The information processing apparatus according to (9), further including

a sensor that outputs a detection value based on behavior of the user,

in which the control section recognizes the behavior of the user on the basis of the detection value, and selects any one of the plurality of variation patterns in response to the behavior.

(11) The information processing apparatus according to any one of (1) to (10),

in which the control section varies magnitude of the variation in the localization position of the sound image over time.

(12) The information processing apparatus according to any one of (1) to (11),

in which the control section acquires user information unique to the user, and determines the importance levels in accordance with the user information.

(13) The information processing apparatus according to (1), further including:

a first vibration section that is located in a first direction relative to the user; and

a second vibration section that is located in a second direction different from the first direction,

in which the text data includes information indicating a traveling direction that the user should follow, and

the control section vibrates a vibration section corresponding to the traveling direction between the first vibration section and the second vibration section.

(14) The information processing apparatus according to (13),

in which the control section vibrates the vibration section corresponding to the traveling direction at a timing other than a timing of reading aloud the traveling direction that the user should follow.

(15) The information processing apparatus according to (14), in which

the text data includes information related to a location ahead of the traveling direction, and

the control section vibrates at least one of the first vibration section or the second vibration section in conformity with a timing of reading aloud the information related to the location ahead of the traveling direction.

(16) The information processing apparatus according to (14) or (15), in which

the text data includes information related to a location ahead of a direction other than the traveling direction, and

the control section vibrates a vibration section corresponding to the direction other than the traveling direction between the first vibration section and the second vibration section.

(17) The information processing apparatus according to (16),

in which the control section vibrates the vibration section corresponding to the direction other than the traveling direction in conformity with the timing of reading aloud the traveling direction that the user should follow, detects whether or not the user has reacted to the vibration, and causes output of voice for reading aloud the information related to the location ahead of the direction other than the traveling direction in the case where the user has reacted.

(18) An information processing method including:

analyzing text data;

determining importance levels of respective pieces of the text data; and

varying a localization position of a sound image of speech voice of the text data with respect to a user in accordance with the importance levels.

(19) A program that causes a computer to execute processes of:

analyzing text data;

determining importance levels of respective pieces of the text data; and

varying a localization position of a sound image of speech voice of the text data with respect to a user in accordance with the importance levels.

### REFERENCE SIGNS LIST

1 control section
9 sound image
12 vibration section
100, 200 wearable device

1. An information processing apparatus comprising:
a control section that analyzes text data, determines importance levels of respective pieces of the text data, and varies a localization position of a sound image of speech voice of the text data with respect to a user in accordance with the importance levels.

2. The information processing apparatus according to claim 1,
wherein the control section varies the localization position of the sound image in such a manner that a distance r of the sound image with respect to the user varies in a spherical coordinate system in accordance with the importance levels.

3. The information processing apparatus according to claim 1,
wherein the control section varies the localization position of the sound image in such a manner that an amplitude θ of the sound image with respect to the user varies in a spherical coordinate system in accordance with the importance levels.

4. The information processing apparatus according to claim 1,
wherein the control section varies the localization position of the sound image in such a manner that an amplitude φ of the sound image with respect to the user varies in a spherical coordinate system in accordance with the importance levels.

5. The information processing apparatus according to claim 1,
wherein the control section is capable of moving the sound image at a predetermined speed, and varies the speed in accordance with the importance levels.

6. The information processing apparatus according to claim 1,
wherein the control section varies the number of sound images in accordance with the importance levels.

7. The information processing apparatus according to claim 1,
wherein the control section varies sound to be output from the sound image in accordance with the importance levels.

8. The information processing apparatus according to claim 1, comprising
at least one of an aroma generation section that generates aroma, a vibration section that generates vibration, or a light generation section that generates light,
wherein the control section varies at least one of the aroma, the vibration, or the light in accordance with the importance levels.

9. The information processing apparatus according to claim 1,
wherein the control section selects any one of a plurality of preliminarily prepared variation patterns of the localization position of the sound image, and varies the localization position of the sound image on a basis of the selected variation pattern.

10. The information processing apparatus according to claim 9, further comprising
a sensor that outputs a detection value based on behavior of the user,
wherein the control section recognizes the behavior of the user on the basis of the detection value, and selects any one of the plurality of variation patterns in response to the behavior.

11. The information processing apparatus according to claim 1,
wherein the control section varies magnitude of the variation in the localization position of the sound image over time.

12. The information processing apparatus according to claim 1,
wherein the control section acquires user information unique to the user, and determines the importance levels in accordance with the user information.

13. The information processing apparatus according to claim 1, further comprising:
a first vibration section that is located in a first direction relative to the user; and
a second vibration section that is located in a second direction different from the first direction,
wherein the text data includes information indicating a traveling direction that the user should follow, and
the control section vibrates a vibration section corresponding to the traveling direction between the first vibration section and the second vibration section.

14. The information processing apparatus according to claim 13,
wherein the control section vibrates the vibration section corresponding to the traveling direction at a timing other than a timing of reading aloud the traveling direction that the user should follow.

15. The information processing apparatus according to claim 14, wherein
the text data includes information related to a location ahead of the traveling direction, and
the control section vibrates at least one of the first vibration section or the second vibration section in conformity with a timing of reading aloud the information related to the location ahead of the traveling direction.

16. The information processing apparatus according to claim 14, wherein
the text data includes information related to a location ahead of a direction other than the traveling direction, and
the control section vibrates a vibration section corresponding to the direction other than the traveling direction between the first vibration section and the second vibration section.

17. The information processing apparatus according to claim 16,
wherein the control section vibrates the vibration section corresponding to the direction other than the traveling direction in conformity with the timing of reading aloud the traveling direction that the user should follow, detects whether or not the user has reacted to the vibration, and causes output of voice for reading aloud the information related to the location ahead of the direction other than the traveling direction in a case where the user has reacted.

18. An information processing method comprising:
analyzing text data;
determining importance levels of respective pieces of the text data; and
varying a localization position of a sound image of speech voice of the text data with respect to a user in accordance with the importance levels.

19. A program that causes a computer to execute processes of:
analyzing text data;
determining importance levels of respective pieces of the text data; and
varying a localization position of a sound image of speech voice of the text data with respect to a user in accordance with the importance levels.
